(19) United States
(12) Patent Application Publication
(10) Pub. No.: US 2017/0176370 A1
(43) Pub. Date: Jun. 22, 2017

(54) GRAPHENE OXIDE SENSORS

(71) Applicants: Massachusetts Institute of Technology, Cambridge, MA (US); Edwards Vacuum, Sanborn, NY (US)

(72) Inventors: Luis Fernando Velasquez-Garcia, Newton, MA (US); Anthony Park Taylor, Boston, MA (US)

(73) Assignees: Massachusetts Institute of Technology, Cambridge, MA (US); Edwards Vacuum, Sanborn, NY (US)

(21) Appl. No.: 15/382,323

(22) Filed: Dec. 16, 2016

Related U.S. Application Data
(60) Provisional application No. 62/268,649, filed on Dec. 17, 2015.

(51) Int. Cl. G01N 27/12; B05D 1/32; B05D 1/06

(52) U.S. Cl. CPC G01N 27/125; B05D 1/06; B05D 1/32

(57) ABSTRACT

Articles and methods involving sensors and thin films suitable for use in sensors are generally provided. In some embodiments, the sensors may comprise a graphene oxide component and/or a thin film with a percolated structure. The sensors may have one or more advantageous properties, such as an appropriate value of resistance, a high degree of sensitivity, and a low response time.

### RELATED APPLICATIONS

This application claims priority under 35 U.S.C. §119(e) to U.S. Provisional Patent Application Ser. No. 62/268,649, filed Dec. 17, 2015 and entitled “Electrospray Printed Graphene Oxide Gas Sensor,” which is incorporated herein by reference in its entirety for all purposes.

### FIELD

The present invention relates generally to systems and methods for detecting gaseous species, such as gaseous water and gaseous ammonia.

### BACKGROUND

Conductometric gas sensors, based on semiconducting metal oxide films, are widely used due to their simplicity, flexibility in production, and broad applicability to many fields. Typically, the adsorption of a gas molecule on the surface of a metal oxide alters surface electronic properties, causing a change in electrical conductivity. Although many metal oxides could be used for gas sensing, only a few show the appropriate combination of adsorption ability, catalytic activity, sensitivity, and thermodynamic stability. These select metal oxides (e.g., SnO₂, TiO₂, and ZnO), however, are the least active from the catalytic point of view. To alleviate this problem, doping with redox-active noble metal nanoparticles, such as Pt, Au, and Pd, is commonly done to enhance conductivity response and gas sensitivity. Unfortunately, noble metals are expensive, thereby precluding their use in low-cost applications.

Additive manufacturing refers to a group of processes that fabricate freeform structures by successively depositing layers of materials according to a digital model. Additive manufacturing started as a visualization tool of passive, mesoscaled parts. However, due to recent improvements in the resolution capabilities of the 3D printers, as well as in the recent demonstration of printable active, i.e., transducing, feedstock, additive manufacturing has become a fabrication technology that could address the complexity, three-dimensionality, and material processing compatibility of certain micro and nanosystems.

Several additive manufacturing technologies have been investigated for the fabrication of micro and nanosystems. The majority of the work has focused on inkjet printing, either piezoelectric based (where the mechanical vibration of a piezo structure overcomes the surface tension of the liquid feedstock to generate droplets) or thermal based (where a heater inside a cavity creates bubbles from the liquid feedstock, which push droplets out of the cavity through a nozzle). Also, pen approaches have been investigated, including dip-pen nanolithography (where solid needles are coated with liquid feedstock) and nano fountain pen manufacturing (where hollow needles deliver liquid feedstock from a pressurized plenum). However, unlike inkjet printing methods, the pen hardware makes contact with the printed substrate, which can cause cross-contamination of the printing head and/or attrition of the printing tip.

Accordingly, improved compositions and methods are desirable.

### SUMMARY

Methods and articles for the detection of gaseous species as well as related compositions and methods associated therewith are provided. The subject matter of the present invention involves, in some cases, interrelated products, alternative solutions to a particular problem, and/or a plurality of different uses of one or more systems and/or articles.

In one aspect, sensors are provided. In some embodiments, a sensor comprises a first electrode, a second electrode, and a graphene oxide component. The graphene oxide component may be in electrical communication with each of the first electrode and the second electrode and a response time of the sensor to a step change in an ambient relative humidity from 10% relative humidity to 50% relative humidity may be less than or equal to 1 minute.

In some embodiments, a sensor comprises a first electrode, a second electrode, and a graphene oxide component. The graphene oxide component may be in electrical communication with each of the first electrode and the second electrode and a resistivity of the graphene oxide component may vary substantially linearly with an ambient relative humidity when the ambient relative humidity is greater than or equal to 10% and less than or equal to 60%.

In some embodiments, a sensor comprises a first electrode, a second electrode, and a graphene oxide component. The graphene oxide component may be in electrical communication with each of the first electrode and the second electrode and a resistivity of the graphene oxide component may be greater than or equal to 200 kilohms and less than or equal to 250 kilohms when an ambient relative humidity is 40%.

Certain embodiments relate to thin films. In some embodiments, a thin film comprises a nanomaterial. The nanomaterial may have a characteristic dimension, an average thickness of the film may be less than or equal to 100 times the characteristic dimension of the nanomaterial, and the nanomaterial may form a percolated network

In some embodiments, a thin film comprises a nanomaterial. The nanomaterial may have a characteristic dimension, a maximum thickness of the thin film along a perimeter may be less than or equal to 200% of an average thickness of the thin film, and the nanomaterial may form a percolated network.

In some aspects, methods are provided. A method may comprise electrospraying a solution comprising a nanomaterial onto a substrate, wherein a temperature of the substrate is at least 15° C. greater than a temperature of the solution.

In some embodiments, a method may comprise electrospraying a solution comprising a nanomaterial onto a substrate, wherein a shadow mask is positioned between a source of the solution and the substrate.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1A shows, according to some embodiments, a schematic illustration of a first electrode, a second electrode, and a graphene oxide component;

FIG. 1B shows, according to some embodiments, a schematic illustration of a first electrode, a second electrode, a third electrode, a fourth electrode, and a graphene oxide component;

FIG. 2A shows, according to some embodiments, a schematic illustration of a thin film;

FIG. 2B shows, according to some embodiments, a schematic illustration of a thin film;

FIG. 3 shows, according to some embodiments, a schematic illustration of a nanomaterial with a length, a width, and a thickness;

FIG. 4A shows, according to some embodiments, a schematic illustration of a method of electrospraying a fluid onto a substrate;

FIG. 4B shows, according to some embodiments, a schematic illustration of a method of electrospraying a fluid onto a substrate through a shadow mask;

FIG. 5 shows, according to some embodiments, a chart displaying the average thicknesses of various thin films;

FIG. 6 shows, according to some embodiments, a schematic depicting a method for forming a graphene oxide sensor;

FIG. 7 shows, according to some embodiments, a chart displaying the response of two sensors to changes in ambient relative humidity;

FIG. 8 shows, according to some embodiments, a chart displaying the resistance of two sensors as a function of ambient relative humidity.

### DETAILED DESCRIPTION

Articles and methods involving sensors are generally provided. Certain embodiments relate to sensors which comprise a graphene oxide component. The graphene oxide component may have one or more features that provide utility for sensing a gaseous species, such as displaying a rapid response to a change in the ambient concentration of the species (e.g., a response time of less than or equal to one minute), a resistance that varies substantially linearly with the ambient concentration of the species (e.g., water), and/or a resistance in a range that is easy to detect with standard electrode setups (e.g., a resistance of greater than or equal to 200 kilohms when the ambient relative humidity is 40%).

Some embodiments relate to materials suitable for forming an active layer of a sensor, such as thin films suitable for forming an active layer of a sensor. A thin film may comprise a nanomaterial (e.g., graphene oxide) that forms a percolated network. If the thin film comprises a conductor or semiconductor, the percolated network may reduce the resistance of the thin film by allowing electrical communication directly between nanomaterial particles in the film without requiring electron transport through non-nanomaterial components. In some embodiments, a thin film may have a thickness less than or equal to 100 times the characteristic dimension of the nanomaterial. In some embodiments, a thin film may display similar properties at the edges of the film than at the center of the film. As an example, the thickness of the film may at the edges may be less than or equal to 200% of the average thickness of the film.

Methods for the formation of sensors and articles for use in sensors are also provided. In some embodiments, a thin film or a sensor component may be fabricated by electrospray printing. A solution comprising a nanomaterial (e.g., graphene oxide) may be electrosprayed onto a substrate. In some embodiments, the substrate may be held at a temperature that is higher than the temperature of the solution. Without wishing to be bound by theory, it is believed that a heated substrate may assist in the fusion of individual droplets in the spray on the surface of the substrate. This phenomenon may enable the formation of a thin film or component with an interconnected (i.e., percolated network) morphology.

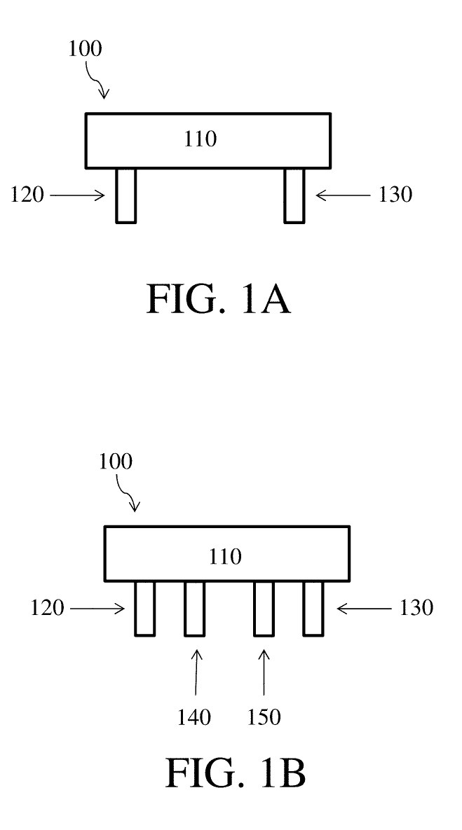

FIG. 1A shows one non-limiting embodiment of a sensor 100 according to certain embodiments of the invention. Sensor 100 comprises graphene oxide component 110, first electrode 120, and second electrode 130. The graphene oxide component may be in electrical communication with at least one of the first electrode and the second electrode, or with each of the first electrode and the second electrode.

As used herein, two components (e.g., graphene oxide and an electrode, one particle and another within a component or film) are considered to be in electrical communication with each other if electrical current can flow between them without passing through an electrical insulator. In some embodiments, current may be capable of flowing between two materials that are in electrical communication without flowing through an intermediate material with a higher resistance than either of the two materials. Components that are in direct electrical communication with each other should be understood to be in electrical communication with each other and be positioned with respect to each other such that current can flow between them without passing through any intermediate components. Components that are in indirect electrical communication with each other should be understood to be in electrical communication with each other and be positioned with respect to each other such that current cannot flow between them without passing through any intermediate components.

In some embodiments, a sensor as described herein may comprise more than two electrodes. For example, a sensor may comprise three electrodes, four electrodes, five electrodes, or more electrodes. In some embodiments, each electrode may be in electrical communication with the graphene oxide component (e.g., a sensor may comprise four electrodes, and each of the four electrodes may be in electrical communication with the graphene oxide component). FIG. 1B shows one non-limiting embodiment of a sensor 100 comprising a graphene oxide component 110, a first electrode 120, a second electrode 130, a third electrode 140, and a fourth electrode 150. While FIG. 1A and FIG. 1B show each electrode positioned beneath the graphene oxide component, other arrangements of the electrodes with respect to the graphene oxide component are also contemplated. For example, one or more electrodes may be positioned above the graphene oxide component or next to the graphene oxide component. Similarly, the arrangement of the electrodes with respect to each other may also be selected as desired (e.g., a first electrode may be positioned between a second electrode and a third electrode, between a third electrode and a fourth electrode, opposite one or more electrodes, and the like).

In some embodiments, a sensor may comprise one or more electrodes that are in direct electrical communication with a current source (e.g., a first electrode, a second electrode), one or more electrodes that are grounded (e.g., a first electrode, a second electrode), and/or one or more electrodes that are floating electrodes (e.g., a third electrode, a fourth electrode). As used herein, a floating electrode is an electrode that is not in direct electrical communication with a source of current and is not grounded.

In some embodiments, a sensor as described herein may be capable of detecting one or more species present in an ambient atmosphere. For instance, the sensor may comprise a graphene oxide component that may have a resistance that varies as the concentration of the species to be detected in the ambient atmosphere varies. The resistance of the graphene oxide component may then be determined in order to determine the concentration of the species in the ambient atmosphere. One non-limiting example of such a detection method may involve exposing the sensor to the species (e.g., to water, to ammonia), passing a current through the graphene oxide component (from, e.g., an electrode in direct electrical communication with a current source to a grounded electrode), measuring the voltage drop across a portion of the graphene oxide (by, e.g., two floating electrodes in direct electrical communication with the graphene oxide component), and using Ohm's law to determine the resistance of the graphene oxide component. Other methods of determining the resistance of the graphene oxide are also possible.

In some embodiments, a sensor may comprise a graphene oxide component (i.e., a component that comprises graphene oxide). As will be known to one of ordinary skill in the art, graphene oxide generally refers to graphene that has been functionalized so that it includes one or more epoxide, carbonyl, carboxyl, and hydroxyl groups. In some embodiments, the graphene oxide may be at least partially reduced. That is, the graphene oxide may have undergone one or more chemical treatments to (e.g., exposure to a base) in order to reduce the oxygen content of the graphene oxide. In some embodiments, graphene oxide that has not been reduced is preferred.

The oxygen content of graphene oxide may generally be selected as desired. In some embodiments, the nanomaterial may be graphene oxide that contains greater than or equal to 1 wt % oxygen, greater than or equal to 2 wt % oxygen, greater than or equal to 5 wt % oxygen, greater than or equal to 10 wt % oxygen, greater than or equal to 20 wt % oxygen, or greater than or equal to 36 wt % oxygen. In some embodiments, the nanomaterial may be graphene oxide that contains less than or equal to 50 wt % oxygen, less than or equal to 36 wt % oxygen, less than or equal to 20 wt % oxygen, less than or equal to 10 wt % oxygen, less than or equal to 5 wt % oxygen, or less than or equal to 2 wt % oxygen. Combinations of the above-referenced ranges are also possible (e.g., greater than or equal to 1 wt % oxygen and less than or equal to 50 wt % oxygen). Other ranges are also possible.

The morphology of the graphene oxide component may also be selected as desired. For example, in some embodiments a graphene oxide component may be a thin film and/or may have a percolating structure, as described in more detail below. In some embodiments, a graphene oxide component may have a morphology that is not a film. For instance, the graphene oxide component may have a spherical, ovoid, cubic, tubular, rod-like, irregular, or bulk morphology. In some embodiments, a graphene oxide component may be a monolayer of graphene oxide sheets or may comprise a monolayer or monolayers of graphene oxide sheets (e.g., at least 2 monolayers, at least 5 monolayers, at least 10 monolayers, at least 20 monolayers, at least 50 monolayers, at least 100 monolayers, at least 200 monolayers, or at least 500 monolayers). The monolayers may be stacked, or they may not be stacked (e.g., graphene oxide sheets monolayers be randomly oriented within the graphene oxide component). In some embodiments, graphene oxide sheets may not form monolayers, and may be randomly oriented within the graphene oxide component. The graphene oxide component may be highly ordered (e.g., may have a crystal structure) may be amorphous, or may contain both regions of order and regions of disorder.

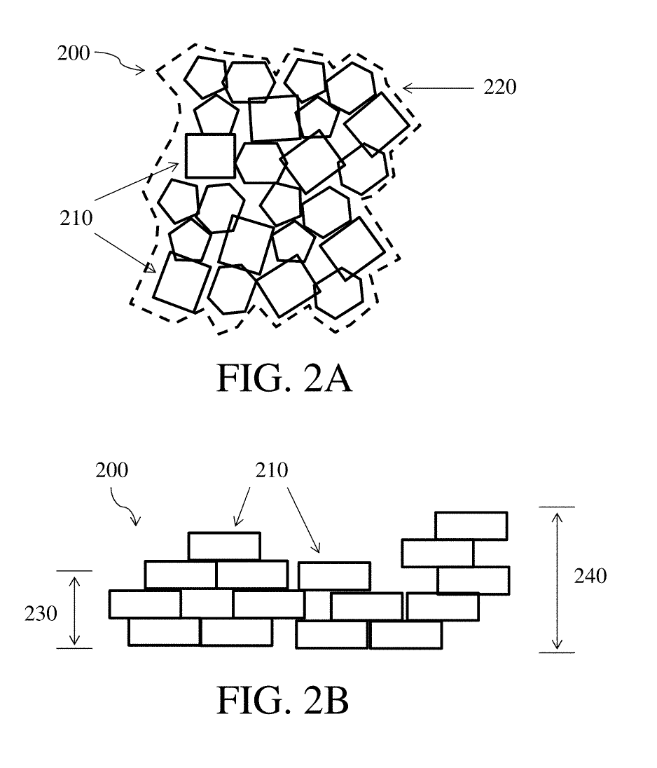

As described above, certain embodiments relate to articles suitable for use in sensors, such as thin films. In some embodiments, the articles (e.g., thin films) described herein may be suitable for use as graphene oxide components. For instance, a sensor may comprise a graphene oxide component that has one or more of the properties of thin films described herein. FIG. 2A shows one non-limiting example of a top view of a thin film 200 comprising nanomaterial 210 with perimeter 220. FIG. 2B shows a side view of the same thin film, which has an average thickness 230 and a maximum thickness along the perimeter 240. It should be noted that while the perimeter is depicted as being slightly offset the outer edge of the thin film for clarity purposes, it should be understood that the perimeter in fact terminates at the outermost boundary of the film in the plane of the thin film. The perimeter, as used herein, should also be understood to refer to an area of the thin film bounded by the external boundary of the thin film and a the locus of points positioned a defined distance (e.g., 10 nm, 20 nm, 50 nm, 100 nm) closer to the center of the thin film than each point making up the external boundary of the thin film.

As shown in FIG. 2A and FIG. 2B, the nanomaterial is typically, but not always, particulate. In some embodiments, the nanomaterial may be particulate and may form a percolating structure within the thin film. The percolating structure may connect a majority (e.g., greater than or equal to 75 wt %, greater than or equal to 90 wt %, greater than or equal to 95 wt %, greater than or equal to 99 wt %, or greater than or equal to 99.9 wt % and less than or equal to 100 wt %) of the nanomaterial particles within the thin film such that they are in electrical communication with each other. That is, greater than or equal to 75 wt %, greater than or equal to 90 wt %, greater than or equal to 95 wt %, greater than or equal to 99 wt %, or greater than or equal to 99.9 wt % and less than or equal to 100 wt % of the nanomaterial particles may be in electrical communication with greater than or equal to 75 wt %, greater than or equal to 90 wt %, greater than or equal to 95 wt %, greater than or equal to 99 wt %, or greater than or equal to 99.9 wt % and less than or equal to 100 wt % of the other nanomaterial particles within the thin film. The above percentages (e.g., of nanomaterial particles in electrical communication with a percolating structure) may be determined by applying a voltage difference across each pair of particles sufficient to cause current to flow across the particle and determining whether current flows. Particles between which current flows are in electrical communication, and those between which current does not flow are not in electrical communication.

In some embodiments, a thin film with a percolating structure may comprise nanomaterial particles and may have a morphology such that greater than or equal to 75 wt %, greater than or equal to 90 wt %, greater than or equal to 95 wt %, greater than or equal to 99 wt %, or greater than or equal to 99.9 wt % and less than or equal to 100 wt % of the nanomaterial particles within the thin film are topologically connected to each other. As used herein, two particles within a film are considered to be in topological communication if it is possible to trace a route through the film from the first particle to the second particle. The extent of the film and particles within the film may be determined by atomic force microscopy.

In some embodiments, an article (e.g., a sensor) may comprise a thin film or a component (e.g., a graphene oxide component that is a thin film) and the thin film or component may comprise one or more nanomaterials. As used herein, a nanomaterial is a material that has at least one dimension that is less than or equal to 1 micron. In some embodiments, a nanomaterial may have at least one dimension that is less than or equal to 500 nm, less than or equal to 200 nm, less than or equal to 100 nm, less than or equal to 50 nm, less than or equal to 20 nm, less than or equal to 10 nm, or less than or equal to 5 nm. Nanomaterials also have a characteristic dimension, which is the thinnest dimension of the nanomaterial. For example, the nanomaterial may comprise sheets and/or flakes that have a thickness and extend in two coordinate dimensions that are orthogonal to both each other and the thickness of the layer. The thickness of the sheets and/or flakes may be smaller (such as, e.g., 10 times smaller, 100 times smaller, etc.) than the other two coordinate directions of the layer. In this case the thickness of the sheet and/or flake may be the characteristic dimension.

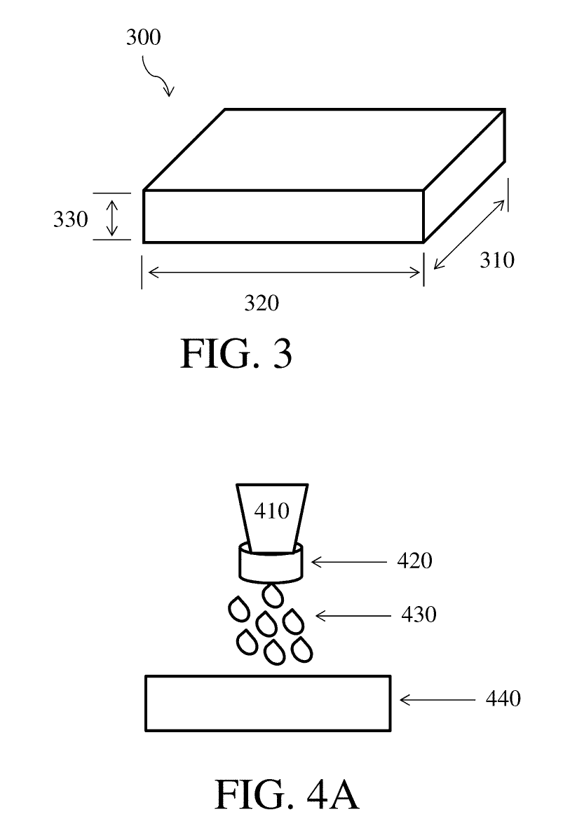

As another example, the nanomaterial may comprise cubes and/or spheres. In such cases, the characteristic dimension would be the side length of the cube and/or the diameter of the sphere. Other shapes for nanomaterials are also contemplated (e.g., rods, irregular shapes, etc.) and the characteristic dimensions for these nanomaterials may be computed in an analogous fashion. FIG. 3 shows one non-limiting embodiment of a nanomaterial 300 with length 310, width 320, and thickness 330. Because the thickness is the thinnest dimension of the nanomaterial shown in FIG. 3, it is the characteristic dimension of that nanomaterial. In some, but not necessarily all embodiments comprising thin films, a majority of the nanomaterial particles within the thin film (e.g., greater than or equal to 75 wt %, greater than or equal to 90 wt %, greater than or equal to 95 wt %, greater than or equal to 99 wt %, or greater than or equal to 99.9 wt % and less than or equal to 100 wt % of the nanomaterial particles within the thin film) to be oriented in the thin film such that their characteristic dimension is perpendicular to the plane of the thin film.

In some embodiments, an article or sensor may comprise a nanomaterial that has a nanoflake morphology (e.g., the article or sensor may comprise graphene oxide nanoflakes). Nanoflakes are typically atomically thin (e.g., in the case of graphene oxide nanoflakes, they are a monolayer sheet of functionalized graphene), and have a characteristic dimension that is less than one nanometer. The size of the nanoflakes in directions perpendicular to their thickness can generally be selected as desired. In some embodiments, nanoflakes may have dimensions perpendicular to their thickness that are greater than or equal to 100 nanometers, greater than or equal to 200 nanometers, greater than or equal to 500 nanometers, greater than or equal to 1 micron, greater than or equal to 2 microns, greater than or equal to 5 microns, greater than or equal to 10 microns, or greater than or equal to 20 microns. In some embodiments, nanoflakes may have dimensions perpendicular to their thickness that are less than or equal to 50 microns, less than or equal to 20 microns, less than or equal to 10 microns, less than or equal to 5 microns, less than or equal to 2 microns, less than or equal to 1 micron, less than or equal to 500 nanometers, or less than or equal to 200 nanometers. Combinations of the above-referenced ranges are also possible (e.g., greater than or equal to 100 nanometers and less than or equal to 50 microns). Other ranges are also possible.

In some embodiments, an article (e.g., a sensor) may comprise a thin film (e.g., a graphene oxide component that is a thin film) and the thin film to be relatively thin. For example, the thin film may have an average thickness of less than or equal to 100 nm, less than or equal to 50 nm, less than or equal to 20 nm, less than or equal to 10 nm, less than or equal to 5 nm, less than or equal to 2 nm, or less than or equal to 1 nm. In some embodiments, the thin film may have an average thickness of greater than or equal to 0.5 nm, greater than or equal to 1 nm, greater than or equal to 2 nm, greater than or equal to 5 nm, greater than or equal to 10 nm, greater than or equal to 20 nm, or greater than or equal to 50 nm. Combinations of the above-referenced ranges are also possible (e.g., greater than or equal to 0.5 nm and less than or equal to 100 nm). Other ranges are also possible. The average thickness of a film may be determined by ellipsometry.

In some embodiments, an article (e.g., a sensor) may comprise a thin film (e.g., a graphene oxide component that is a thin film) and the thin film may have a thickness that has a defined relationship to the characteristic dimension of a nanomaterial within the thin film. In some embodiments, the thin film may have a thickness that is less than or equal to 100 times the characteristic dimension of the nanomaterial, less than or equal to 50 times the characteristic dimension of the nanomaterial, less than or equal to 20 times the characteristic dimension of the nanomaterial, less than or equal to 10 times the characteristic dimension of the nanomaterial, less than or equal to 5 times the characteristic dimension of the nanomaterial, or less than or equal to 2 times the characteristic dimension of the nanomaterial. In some embodiments, the thickness of the thin film may be greater than or equal to 1 times the characteristic dimension of the nanomaterial, greater than or equal to 2 times the characteristic dimension of the nanomaterial, greater than or equal to 5 times the characteristic dimension of the nanomaterial, greater than or equal to 10 times the characteristic dimension of the nanomaterial, greater than or equal to 20 times the characteristic dimension of the nanomaterial, or greater than or equal to 50 times the characteristic dimension of the nanomaterial. Combinations of the above-referenced ranges are also possible (e.g., greater than or equal to 1 times the characteristic dimension of the nanomaterial and less than or equal to 100 times the characteristic dimension of the nanomaterial). Other ranges are also possible.

In some embodiments, an article (e.g., a sensor) may comprise a thin film (e.g., a graphene oxide component that is a thin film) and the thin film may have thickness along its edges that is similar in magnitude to its average thickness. For instance, the maximum thickness of the thin film along its perimeter may be less than or equal to 1000% of the average thickness of the thin film, less than or equal to 500% of the average thickness of the thin film, less than or equal to 200% of the average thickness of the thin film, or less than or equal to 100% of the average thickness of the thin film. In some embodiments, the maximum thickness of the thin film along its perimeter may be greater than or equal to 50% of the average thickness of the thin film, greater than or equal to 100% of the average thickness of the thin film, greater than or equal to 200% of the average thickness of the thin film, or greater than or equal to 500% of the average thickness of the thin film. Combinations of the above-referenced ranges are also possible (e.g., greater than or equal to 50% of the average thickness of the thin film and less than or equal to 1000% of the average thickness of the thin film). Other ranges are also possible. The maximum thickness of a thin film along its perimeter may be determined by scanning the film using an atomic force microscope and recording the maximum height measured along the film perimeter.

In some embodiments, an article (e.g., a sensor) may comprise a thin film (e.g., a graphene oxide component that is a thin film) and the thin film may be substantially free of binder. For example, the thin film may be substantially free of polymeric components, or substantially free of components which are not nanomaterials. In some embodiments, a binder may make up less than or equal to 10 wt % of the thin film, less than or equal to 5 wt % of the thin film, less than or equal to 2 wt % of the thin film, or less than or equal to 1 wt % of the thin film. In some embodiments, a binder may make up greater than or equal to 0 wt % of the thin film, greater than or equal to 1 wt % of the thin film, greater than or equal to 2 wt % of the thin film, or greater than or equal to 5 wt % of the thin film. Combinations of the above-referenced ranges are also possible (e.g., greater than or equal to 0 wt % and less than or equal to 10 wt %). Other ranges are also possible. In some embodiments, the film may be completely free of binder.

In some embodiments, a sensor may comprise a graphene oxide component, and the graphene oxide component may have one or more beneficial properties. For example, the resistance of the graphene oxide component may change quickly when exposed to a change in the concentration of a species to be detected (e.g., to a change in ambient relative humidity, to a change in ammonia concentration). That is, the graphene oxide component may have a low response time. As used herein, the response time of a material is the amount of time that elapses between the exposure of the material to a stimuli (e.g., humidity) and time at which the resistance of the material has changed by at least 95% of the amount that it would change after infinite exposure to the stimuli (i.e., resistance increases or decreases by 95% of the amount that it would increase or decrease after infinite exposure to the stimuli). In some embodiments, a graphene oxide component may have a response time of less than or equal to 10 minutes, less than or equal to 5 minutes, less than or equal to 2 minutes, less than or equal to 1 minute, less than or equal to 30 seconds, less than or equal to 15 seconds, or less than or equal to 5 seconds in response to a step change in ambient relative humidity (e.g., from 1% relative humidity to 99% relative humidity, from 10% relative humidity to 50% relative humidity, from 10% relative humidity to 40% relative humidity, from 20% relative humidity to 30% relative humidity, and the like). In some embodiments, a graphene oxide component may have a response time of greater than or equal to 1 second, greater than or equal to 5 seconds, greater than or equal to 15 seconds, greater than or equal to 30 seconds, greater than or equal to 1 minute, greater than or equal to 2 minutes, or greater than or equal to 5 minutes in response to a step change in ambient relative humidity (e.g., from 1% relative humidity to 99% relative humidity, from 10% relative humidity to 50% relative humidity, from 10% relative humidity to 40% relative humidity, from 20% relative humidity to 30% relative humidity, and the like). Combinations of the above-referenced ranges are also possible (e.g., greater than or equal to 1 second and less than or equal to 10 minutes). Other ranges are also possible. As used herein, ambient relative humidity refers to the relative humidity (i.e., the ratio of the partial pressure of water vapor to the equilibrium water vapor pressure) in the gaseous atmosphere surrounding the sensor. Ambient relative humidity can be determined by using a commercial humidity sensor (e.g., a Honeywell HIH-4000 sensor) positioned in the same gaseous atmosphere.

In some embodiments, a graphene oxide component may have a response time of less than or equal to 10 minutes, less than or equal to 5 minutes, less than or equal to 2 minutes, less than or equal to 1 minute, less than or equal to 30 seconds, less than or equal to 15 seconds, or less than or equal to 5 seconds upon exposure to ammonia. In some embodiments, a graphene oxide component may have a response time of greater than or equal to 1 second, greater than or equal to 5 seconds, greater than or equal to 15 seconds, greater than or equal to 30 seconds, greater than or equal to 1 minute, greater than or equal to 2 minutes, or greater than or equal to 5 minutes upon exposure to ammonia. Combinations of the above-referenced ranges are also possible (e.g., greater than or equal to 1 second and less than or equal to 10 minutes). Other ranges are also possible. The response time of a graphene oxide component to ammonia may be determined by exposing the graphene oxide component to an atmosphere containing a known concentration of ammonia and measuring the evolution of the resistivity of the graphene oxide component as a function of time after exposure to the ammonia.

In some embodiments, a sensor may be able to detect a species (e.g., water, ammonia) at a relatively low level. For example, in some embodiments the sensor may be capable of detecting ammonia at a level of less than or equal to 5000 ppm, less than or equal to 2000 ppm, less than or equal to 1000 ppm, less than or equal to 500 ppm, less than or equal to 200 ppm, or less than or equal to 100 ppm. In some embodiments, the sensor may be capable of detecting ammonia at a level of greater than or equal to 50 ppm, greater than or equal to 100 ppm, greater than or equal to 200 ppm, greater than or equal to 500 ppm, greater than or equal to 1000 ppm, or greater than or equal to 2000 ppm. Combinations of the above-referenced ranges are also possible (e.g., greater than or equal to 50 ppm and less than or equal to 5000 ppm). Other ranges are also possible. The ability of a sensor to detect a species at a specified concentration may be determined by exposing the sensor to an ambient atmosphere comprising the species at that concentration and determining whether there is a measurable change in the resistance of the graphene oxide component of the sensor (e.g., a change of greater than or equal to 2%, greater than or equal to 5%, or greater than or equal to 10% and less than or equal to 10000%).

In some embodiments, a sensor may comprise a graphene oxide component, and the graphene oxide component may have a resistance that varies substantially linearly with an ambient relative humidity when the ambient relative humidity is between two values (e.g., greater than or equal to 1% and less than or equal to 99%, greater than or equal to 10% and less than or equal to 60%, greater than or equal to 10% and less than or equal to 50%, greater than or equal to 20% and less than or equal to 60%, greater than or equal to 20% and less than or equal to 60%, and the like). As used herein, a first parameter (e.g., resistance) is considered to vary substantially linearly with a second parameter (e.g., ambient relative humidity) when, after taking at least ten measurements of the first parameter at ten different values of the second parameter, a linear equation for the first parameter in terms of the second parameter can be established with an R² value of greater than or equal to 0.8. In some embodiments, the R² value may be higher. For example, a linear equation may be established to describe the variation of a first parameter (e.g., resistance) with respect to a second parameter (e.g., humidity) with an R² value of greater than or equal to 0.9, greater than or equal to 0.95, or greater than or equal to 0.99 and less than or equal to 1.

In some embodiments, a sensor may comprise a graphene oxide component whose resistance increases when the ambient relative humidity increases. In some embodiments, the ratio of the increase in the resistance of the graphene oxide component to the increase in the ambient relative humidity is greater than or equal to 1, greater than or equal to 1.2, greater than or equal to 1.3, greater than or equal to 1.4, greater than or equal to 1.5, greater than or equal to 1.6, greater than or equal to 1.7, greater than or equal to 1.8, or greater than or equal to 1.9. In some embodiments, the ratio of the increase in the resistance of the graphene oxide component to the increase in the ambient relative humidity is less than or equal to 2, less than or equal to 1.9, less than or equal to 1.8, less than or equal to 1.7, less than or equal to 1.6, less than or equal to 1.5, less than or equal to 1.4, less than or equal to 1.3, less than or equal to 1.2, or less than or equal to 1.1. Combinations of the above-referenced ranges are also possible (e.g., greater than or equal to 1 and less than or equal to 2). Other ranges are also possible.

In embodiments that comprise a graphene oxide component, the resistance of the graphene oxide component may be selected as desired. In some embodiments, the graphene oxide component may be greater than or equal to 200 kilohms, greater than or equal to 210 kilohms, greater than or equal to 220 kilohms, greater than or equal to 230 kilohms, or greater than or equal to 240 kilohms when the ambient relative humidity is 40%. In some embodiments, the graphene oxide component may be less than or equal to 250 kilohms, less than or equal to 240 kilohms, less than or equal to 230 kilohms, less than or equal to 220 kilohms, or less than or equal to 210 kilohms when the ambient relative humidity is 40%. Combinations of the above-referenced ranges are also possible (e.g., greater than or equal to 200 kilohms and less than or equal to 250 kilohms). Other ranges are also possible.

As described above, certain embodiments relate to sensors that comprise one or more electrodes. In some embodiments, one or more electrodes may comprise a metal, such as one or more transition metals. In some embodiments, one or more electrodes may comprise gold and/or chromium. For example, one or more electrodes may comprise a gold layer disposed on a chromium layer.

The thickness of each layer of the electrode, and of the electrode as a whole, may be selected as desired. In some embodiments, one or more electrodes may have a thickness of greater than or equal to 50 nm, greater than or equal to 100 nm, or greater than or equal to 200 nm. In some embodiments, one or more electrodes may have a thickness of less than or equal to 500 nm, less than or equal to 200 nm, or less than or equal to 100 nm. Combinations of the above-referenced ranges are also possible (e.g., greater than or equal to 50 nm and less than or equal to 500 nm). Other ranges are also possible.

In some embodiments, one or more electrodes may comprise a gold layer, and the thickness of the gold layer may be greater than or equal to 50 nm, greater than or equal to 100 nm, or greater than or equal to 200 nm. In some embodiments, one or more electrodes may comprise a gold layer and the thickness of the gold layer may be less than or equal to 500 nm, less than or equal to 200 nm, or less than or equal to 100 nm. Combinations of the above-referenced ranges are also possible (e.g., greater than or equal to 50 nm and less than or equal to 500 nm). Other ranges are also possible.

In some embodiments, one or more electrodes may comprise a chromium layer, and the thickness of the chromium layer may be greater than or equal to 1 nm, greater than or equal to 2 nm, greater than or equal to 5 nm, greater than or equal to 10 nm, or greater than or equal to 20 nm. In some embodiments, one or more electrodes may comprise a chromium layer and the thickness of the chromium layer may be less than or equal to 50 nm, less than or equal to 20 nm, less than or equal to 10 nm, less than or equal to 5 nm, or less than or equal to 2 nm. Combinations of the above-referenced ranges are also possible (e.g., greater than or equal to 1 nm and less than or equal to 50 nm). Other ranges are also possible.

The width of any of the electrodes may generally be selected as desired. In some embodiments, one or more electrodes may have a width of greater than or equal to 1 micron, greater than or equal to 2 microns, greater than or equal to 5 microns, greater than or equal to 10 microns, greater than or equal to 20 microns, or greater than or equal to 50 microns. In some embodiments, one or more electrodes may have a width of less than or equal to 100 microns, less than or equal to 50 microns, less than or equal to 20 microns, less than or equal to 10 microns, less than or equal to 5 microns, or less than or equal to 2 microns. Combinations of the above-referenced ranges are also possible (e.g., greater than or equal to micron and less than or equal to 100 microns). Other ranges are also possible.

The electrodes may be positioned with respect to each other as desired. In some embodiments, the active area of the sensor (i.e., the area of the graphene oxide component positioned between the first electrode and the second electrode) may be greater than or equal to 0.001 mm², greater than or equal to 0.002 mm², greater than or equal to 0.005 mm², greater than or equal to 0.01 mm², greater than or equal to 0.02 mm², or greater than or equal to 0.05 mm². In some embodiments, the active area of the sensor may be less than or equal to 0.1 mm², less than or equal to 0.05 mm², less than or equal to 0.02 mm², less than or equal to 0.01 mm², less than or equal to 0.005 mm², or less than or equal to 0.002 mm². Combinations of the above-referenced ranges are also possible (e.g., greater than or equal to 0.001 mm² and less than or equal to 0.1 mm²). Other ranges are also possible.

In some embodiments, a sensor may comprise at least four electrodes and the active area between the third electrode and the fourth electrode (i.e., the area of the graphene oxide component positioned between the third electrode and the fourth electrode) may be greater than or equal to 0.002 mm², greater than or equal to 0.005 mm², greater than or equal to 0.01 mm², greater than or equal to 0.02 mm², greater than or equal to 0.05 mm², or greater than or equal to 0.1 mm². In some embodiments, the active area between the third electrode and the fourth electrode may be less than or equal to 0.2 mm², less than or equal to 0.1 mm², less than or equal to 0.05 mm², less than or equal to 0.02 mm², less than or equal to 0.01 mm², or less than or equal to 0.005 mm². Combinations of the above-referenced ranges are also possible (e.g., greater than or equal to 0.002 mm² and less than or equal to 0.02 mm²). Other ranges are also possible.

In some embodiments, any two electrodes (e.g., a first electrode and a third electrode, a third electrode and a fourth electrode, a fourth electrode and a second electrode) may be separated by any suitable distance. In some embodiments, the separation between any two electrodes (e.g., a first electrode and a third electrode, a third electrode and a fourth electrode, a fourth electrode and a second electrode) may be greater than or equal to 5 microns, greater than or equal to 10 microns, greater than or equal to 20 microns, greater than or equal to 50 microns, greater than or equal to 100 microns, or greater than or equal to 200 microns. In some embodiments, the separation between any two electrodes may be less than or equal to 500 microns, less than or equal to 200 microns, less than or equal to 100 microns, less than or equal to 50 microns, less than or equal to 20 microns, or less than or equal to 10 microns. Combinations of the above-referenced ranges are also possible (e.g., greater than or equal to 5 microns and less than or equal to 500 microns). Other ranges are also possible.

In some embodiments, one or more articles described herein (e.g., a sensor, a thin film, a first electrode, a second electrode, a third electrode, a fourth electrode) may be disposed on a substrate. The substrate may be made from any suitable material. In some embodiments, the substrate may comprise a semiconductor, such as silicon. In some embodiments, the substrate may comprise a coating, such as a silicon oxide coating.

The substrate may have any suitable shape. In some embodiments, the substrate may be flat. In some embodiments, the substrate or at least a portion of the substrate may be curved (e.g., at least a portion of the substrate may be convex and/or at least a portion of the substrate may be concave).

In some embodiments, a sensor as described herein may consume a relatively low amount of power. For example, a sensor may consume less than or equal to 50 microwatts, less than or equal to 20 microwatts, less than or equal to 10 microwatts, less than or equal to 6 microwatts, less than or equal to 2 microwatts, or less than or equal to 1 microwatts when exposed to air with a relative humidity of less than 60%. In some embodiments, the sensor may consume greater than or equal to 0.5 microwatts, greater than or equal to 1 microwatts, greater than or equal to 2 microwatts, greater than or equal to 5 microwatts, greater than or equal to 10 microwatts, greater than or equal to 6 microwatts, greater than or equal to 10 microwatts, or greater than or equal to 20 microwatts. Combinations of the above-referenced ranges are also possible (e.g., greater than or equal to 0.5 microwatts and less than or equal to 50 microwatts). Other ranges are also possible.

Sensors described herein may be used to detect any suitable species. Non-limiting examples of species that may be detected include water, acids, bases, ammonia, oxygen, carbon tetrafluoride, nitrous oxide, halogens, hydrochloric acid, and hydrofluoric acid. In some embodiments, the species to be detected may comprise a gas (e.g., water vapor).

In some embodiments, a sensor as described herein may be used to detect species at atmospheric pressure. In some embodiments, a sensor as described herein may be used to detect species at a reduced pressure (e.g., under vacuum conditions). In some embodiments, a sensor as described herein may be used to detect species at a pressure of less than or equal to 1 atm, less than or equal to 0.5 atm, less than or equal to 0.2 atm, less than or equal to 0.1 atm, less than or equal to 0.05 atm, less than or equal to 0.02 atm, less than or equal to 0.01 atm, less than or equal to 0.005 atm, less than or equal to 0.002 atm, less than or equal to 0.001 atm, less than or equal to 0.0005 atm, or less than or equal to 0.0002 atm. In some embodiments, a sensor as described herein may be used to detect species at a pressure of greater than or equal to 0.0001 atm, greater than or equal to 0.0002 atm, greater than or equal to 0.0005 atm, greater than or equal to 0.001 atm, greater than or equal to 0.002 atm, greater than or equal to 0.005 atm, greater than or equal to 0.01 atm, greater than or equal to 0.02 atm, greater than or equal to 0.05 atm, greater than or equal to 0.1 atm, greater than or equal to 0.2 atm, or greater than or equal to 0.5 atm. Combinations of the above-referenced ranges are also possible (e.g., greater than or equal to 0.0001 atm and less than or equal to 1 atm). Other ranges are also possible.

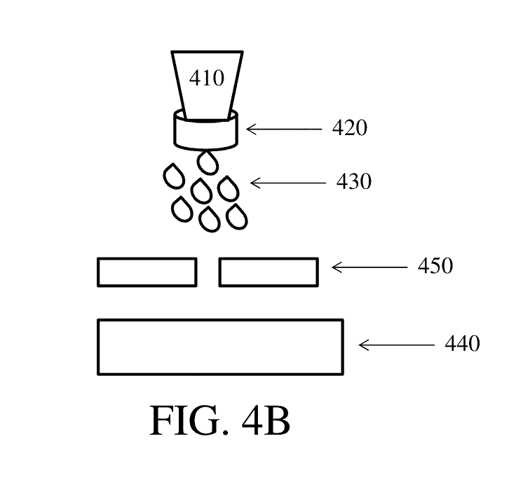

As described above, certain inventive embodiments relate to methods for forming articles using electrospray techniques. Electrospraying may comprise passing a fluid through an electric field. The electrical field is typically created between an emitter with a high bias voltage and a substrate held at a different voltage than the emitter. The emitter may be an aperture held at an electrical bias (e.g., a 3 kV bias) through which the fluid can pass through. The substrate is typically, but not always, grounded. As the fluid passes through the aperture, it may become charged. After charging, the fluid may be electrically attracted to the grounded substrate. Electrospraying a fluid comprising a liquid and a solid (e.g., a dissolved solid, a suspended solid, and the like) may result in the formation of a solid film on the substrate after the liquid in the fluid has evaporated. FIG. 4A shows one non-limiting embodiment of an electrospray process, where fluid 410 passes through aperture 420 to form droplets 430 that are attracted to grounded substrate 440.

In some embodiments, the aperture may be rastered across the surface of the substrate during the electrospray process. That is, aperture may be translated in grid pattern over the entirety of the surface of the substrate.

In some embodiments, a shadow mask may be positioned the electrosprayed droplets and the substrate. FIG. 4B shows one such embodiment, where shadow mask 450 is positioned between droplets 430 and substrate 440. The shadow mask may allow for the deposition of an electrosprayed article (e.g., a thin film, a graphene oxide component) in an area on the substrate with a desired position and area defined by the shadow mask.

Although FIG. 4B depicts a one layer shadow mask, shadow masks with more than one layer are also contemplated. For instance, certain methods relate to electrospraying through two shadow masks. Without wishing to be bound by theory, two shadow masks may be beneficial because they may allow for the formation of thin films or components that do not have substantially higher thicknesses at the perimeter of the thin film or component than in the center of the thin film or component. In some embodiments, a shadow mask may comprise two layers and the layer closer to the aperture may have a smaller diameter than the layer farther from the aperture.

While FIG. 4B depicts a shadow mask that has a diameter smaller than the extent of the electrospray, it is also possible that the shadow mask may have a diameter that is on the order of the extent of the electrospray, or greater than the extent of the electrospray.

In some embodiments, a fluid may be electrosprayed onto a heated substrate. For example, the temperature of the substrate may be greater than or equal to 30° C., greater than or equal to 35° C., greater than or equal to 40° C., greater than or equal to 45° C., greater than or equal to 50° C., greater than or equal to 55° C., greater than or equal to 60° C., or greater than or equal to 65° C. In some embodiments, the temperature of the substrate may be less than or equal to 70° C., less than or equal to 65° C., less than or equal to 60° C., less than or equal to 55° C., less than or equal to 50° C., less than or equal to 45° C., less than or equal to 40° C., or less than or equal to 35° C. Combinations of the above-referenced ranges are also possible (e.g., greater than or equal to 30° C. and less than or equal to 70° C.). Other ranges are also possible. As used herein, the temperature of the substrate refers to temperature at the substrate surface proximate the fluid being electrosprayed. Methods for measuring temperature are known to those of ordinary skill in the art (e.g., a thermometer may be held against the substrate).

In some embodiments, a fluid may be electrosprayed onto a substrate that is held at a higher temperature than the fluid. In some embodiments, the temperature of the substrate may be greater than or equal to 5° C. greater than a temperature of the fluid, greater than or equal to 10° C. greater than a temperature of the fluid, greater than or equal to 15° C. greater than a temperature of the fluid, greater than or equal to 20° C. greater than a temperature of the fluid, or greater than or equal to 25° C. greater than a temperature of the fluid. In some embodiments, the temperature of the substrate may be less than or equal to 30° C. greater than the temperature of the fluid, less than or equal to 25° C. greater than the temperature of the fluid, less than or equal to 20° C. greater than the temperature of the fluid, less than or equal to 15° C. greater than the temperature of the fluid, or less than or equal to 10° C. greater than the temperature of the fluid. Combinations of the above-referenced ranges are also possible (e.g., greater than or equal to 5° C. and less than or equal to 30° C. greater than the temperature of the fluid). Other ranges are also possible. The temperature of the fluid may be measured by reading a thermometer in contact with the fluid upstream of the aperture.

### EXAMPLE 1

In this example, low-cost graphene oxide (GO) gas sensors are reported. The devices have a ˜50 nm thick transducing element fabricated at low temperature (<65° C.) using electrospray printing of GO nanoflakes with a shadow mask. No post treatment to the devices was conducted; the devices were neither annealed nor doped. Devices with multiple electrode configurations were fabricated on SiO₂-coated Si substrates using contact photolithography and lift-off techniques. The devices were characterized as humidity sensors using a home-built environmental chamber at atmospheric pressure while varying the relative humidity (RH) between 10% and 60%; the response was benchmarked using a commercial humidity sensor. The devices were also characterized as sensors of ammonia in vacuum at room temperature and 1 Torr pressure.

A custom-built electrospray printer was employed to deposit GO thin films onto substrates at atmospheric pressure using a liquid feedstock composed of GO nanoflakes in an aqueous suspension. The liquid feedstock was delivered via a syringe pump to a blunt hollow stainless steel needle with a 300 micron inner diameter. The starting feedstock is a commercial GO solution (Sigma Aldrich product 777676) with a concentration of 4 mg/mL GO in water. The original feedstock was diluted using deionized water to concentrations in the 1-40 micrograms/mL range. A grounded stainless steel annular electrode with a circular aperture was positioned in the plane of the tip so that the axis of the tip was at the center of the electrode aperture, and a high-voltage power supply biased the needle at 3 kV to produce droplet emission. The substrate that received the imprint was on a temperature-controlled heated plate, and the assembly was mounted on a PC-controlled three-axis stage above the needle. To conduct a film deposition, the substrate was first mounted on the heated stage and brought to temperature for about 5 min. The GO nanoflake solution was then loaded into the syringe pump, and the system was primed up to the tip of the emitter. After this, the syringe pump was activated, delivering the feedstock at a flow rate of around 1 microliter per minute, and a high bias voltage is applied to the tip and adjusted to yield a stable Taylor cone. The beam of GO droplets was positioned to the side of the substrate and observations were made to ensure that the emission was stable. Finally, a deposition recipe (i.e., a sequence of commands that move the stage in a pre-established fashion) was run.

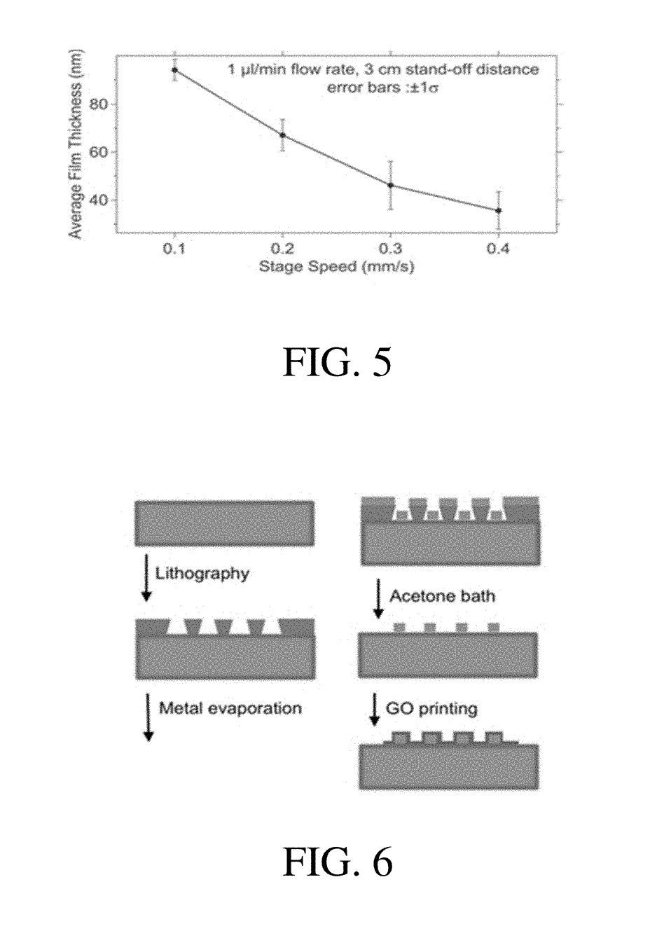

Optimization experiments with the home-built electrospray printer were conducted to deposit interconnected films by keeping constant the flow rate and bias voltage while varying the separation distance, stage speed, number of passes, and surface temperature. Average film thicknesses down to 30 nm were measured using a Dektak profilometer (FIG. 5). Films were deposited at temperatures between room temperature and 64° C. Some films deposited between 50° C. and 64° C. had limited thickness variation across the coating and did not show the liquid accumulation at the edges of the imprints created on unheated samples. In one example, an electrosprayed GO film was deposited on top of a 300 nm SiO₂ film on a Si substrate. This film displayed an interconnected network of GO nanoflakes.

In some experiments, a single shadow mask (stainless steel, 250 micron thick, 1.3 mm diameter aperture) was used to create the imprints. In other experiments, a two-layer shadow mask was implemented (two stainless steel sheets, each 125 micron thick, bottom layer 1.3 mm diameter aperture, top layer 1.0 mm diameter aperture, concentrically mounted). With the two-layer shadow mask and under optimized conditions, GO films with average thickness less than 100 nm were successfully manufactured.

A process flow that was used to fabricate GO gas sensors is shown in FIG. 6. The starting substrates were 1 cm-wide square pieces of single-crystal silicon coated with 500 nm of thermal oxide. First, image reversal contact lithography was conducted in a spun-coated thin film of photoresist to transfer the layouts of the electrodes; after development, the patterned photoresist films were optionally inspected to verify that the exposed areas were free of photoresist. Next, 100 nm thick Au films on top of a 10 nm thick Cr films were deposited everywhere on the substrate using electron beam evaporation. The photoresist was then dissolved using acetone, removing the metal stack everywhere on the substrates except for the features defined by lithography, thereby manufacturing the sensor electrodes by a lift-off technique. The fabrication of the devices was completed by electrospraying a suspension of GO nanoflakes on top of the electrodes while the substrates were slightly heated. The completed sensor chips could optionally be placed in standard IC packages with Au wire-bonds.

For the sensors with the smallest electrode structure studied here, the devices had an active area of about 0.03 mm² between the two inner electrodes (0.076 mm² total active area); the metallization lines underneath the active area were 10 microns wide and were separated by 50 microns.

The packaged sensors were placed inside a custom-built environmental chamber where the RH was varied between 10% and 60%. A commercial humidity sensor (Honeywell HIH-4000) was mounted near the GO sensor for comparison. In the standard four-point probe configuration of the GO sensor, current was supplied to electrode 1 with a source-measuring unit (SMU) Keithley 2612B, electrodes 2 and 3 were floating, and electrode 4 was connected to ground. The resistance across pins 2 and 3 was calculated using the formula R₂₃=(V₂−V₃)/I₁. Through experimentation, it was determined that an optimal current value of 2 microamps supplied to electrode 1 yielded the largest difference in voltage between electrodes 2 and 3. Voltage readings of the electrodes were logged on the GO sensor and the commercial humidity sensor with a Dataq DI-149, which is an eight-channel data logger that samples data at a rate of 20 Hz. The outputs from the GO devices had large signal-to-noise ratios; therefore, signal processing was not required.

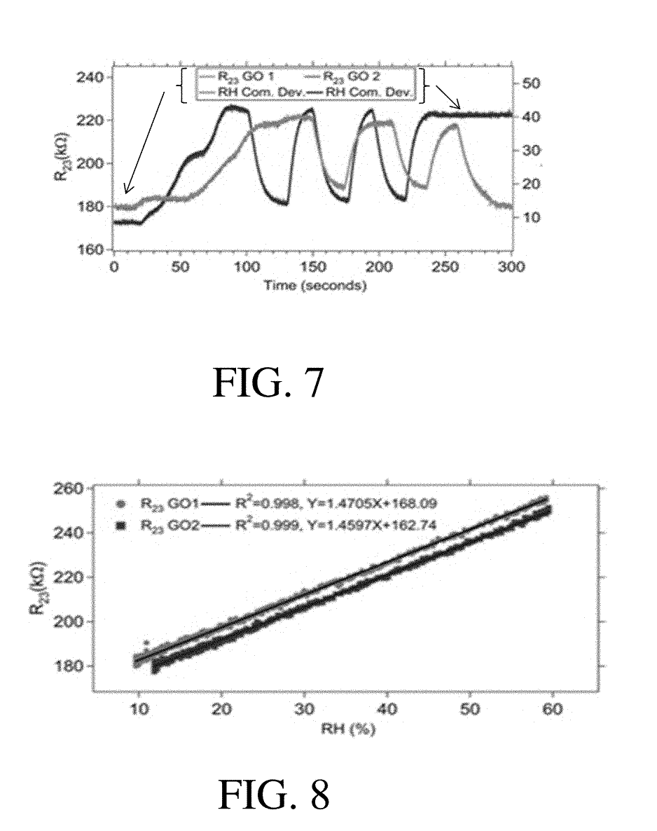

Two kinds of experiments were conducted to characterize the devices as humidity sensors. In the first kind of experiments the GO sensors were characterized dynamically, that is, the capability of the printed sensors to track the RH as it ‘quickly’ changed within the chamber of the apparatus (time scale on the order of tens of seconds) was benchmarked. FIG. 7 shows the dynamic response as humidity sensor of two different GO devices, i.e., GO1 and GO2; the dynamic response of the commercial sensor while each printed sensor was characterized is also reported. The GO sensors were made with slightly different printing recipes, described in Table 1, which yielded devices with different GO film thicknesses.

TABLE 1

| | GO | Flow | Surface | Stage | Stage | Passes | | Line |
|---|---|---|---|---|---|---|---|---|
| | dilution | rate | temperature | separation | speed | per | | spacing |
| Sample | (ug/mL) | (uL/min) | (° C.) | (cm) | (mm/s) | line | Lines | (mm) |
| GO1 | 2 | 2 | 64 | 3 | 0.22 | 5 | 8 | 0.3 |
| GO2 | 20 | 2 | 60 | 3 | 0.22 | 1 | 24 | 0.1 |

In the second kind of experiments the relationship between the resistance of the sensors and the RH was characterized. A linear relationship between the resistance of the GO sensors and the RH in the 10-60% range was measured (FIG. 8). The power consumption of the printed sensors was estimated at 6 microwatts or less over the 10-60% RH range.

The ability to detect small quantities of reactive gases downstream of a semiconductor process chamber is advantageous from a mass balance perspective for calculating the destructive efficiency of gas abatement equipment, and may be beneficial for many industrial installations to comply with environmental regulations. A series of tests with the printed GO sensors were conducted in a commercial PlasmaTherm System VII plasma-enhanced chemical vapor deposition reactor to detect traces of ammonia in a balance of nitrogen. The composition of the vacuum was adjusted using the mass flow controllers (MFCs) of the reactor, each controlling a different gas, and the pressure inside the chamber is regulated by a closed-loop system with a butterfly valve. With the pressure inside the reactor controlled to 950 mT and the susceptor temperature held at 30° C., reactive gas mixtures were admitted in increasing dosages for 4 min followed by 4 min of chamber evacuation. The concentrations of reactive gases ranging from 500 ppm to 7300 ppm were limited to the capabilities of MFCs installed in the PlasmaTherm (15 sccm for NH₃ and 2000 sccm for N₂).

Similar to the humidity tests previously reported, the current was supplied to the electrode 1 with a SMU Keithley 2612B and voltages were measured with a Dataq DI-149 data-logger on pins 1, 2, and 3 of the device at a 20 Hz sampling rate. The output signals from the printed GO devices were smoothed using boxcar averaging over a 4.25 s window. Currents ranging from 6-12 microamps were found to be suitable for detecting for NH₃.

The resistance of the electrospray-printed GO devices decayed with an exponential behavior upon exposure to ammonia during the 4 min doses at different concentrations. From the curve fits, the estimated time to equilibrium is 10-20 min. After the exposure to ammonia was completed, the resistance of the device trended back towards the initial value.

Low-cost conductometric gas sensors that use an ultrathin film made of a matrix of GO nanoflakes as transducing element have been reported. The devices were fabricated by lift-off metallization and near-room temperature, atmospheric pressure electrospray printing using a shadow mask. The sensors are sensitive to reactive gases at room temperature without requiring any post heat treatment, harsh chemical reduction, or doping with metal nanoparticles. The sensors' response to humidity at atmospheric pressure is linear with changes in humidity in the 10%-60% RH range. Moreover, devices with GO layers printed by different deposition recipes yielded similar response characteristics. Finally, the printed GO devices successfully detected ammonia at concentrations down to 500 ppm (absolute partial pressure of 5×10⁻⁴ T) at ˜1 T pressure, room temperature conditions. The sensor technology can be used in a great variety of atmospheric and sub-atmospheric conditions to aid in industrial process control of applications such as air conditioning and sensing of reactive gas species in vacuum lines and abatement systems.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

Any terms as used herein related to shape, orientation, alignment, and/or geometric relationship of or between, for example, one or more articles, structures, forces, fields, flows, directions/trajectories, and/or subcomponents thereof and/or combinations thereof and/or any other tangible or intangible elements not listed above amenable to characterization by such terms, unless otherwise defined or indicated, shall be understood to not require absolute conformance to a mathematical definition of such term, but, rather, shall be understood to indicate conformance to the mathematical definition of such term to the extent possible for the subject matter so characterized as would be understood by one skilled in the art most closely related to such subject matter. Examples of such terms related to shape, orientation, and/or geometric relationship include, but are not limited to terms descriptive of: shape—such as, round, square, circular/circle, rectangular/rectangle, triangular/triangle, cylindrical/cylinder, elliptical/ellipse, (n)polygonal/(n)polygon, etc.; angular orientation—such as perpendicular, orthogonal, parallel, vertical, horizontal, collinear, etc.; contour and/or trajectory—such as, plane/planar, coplanar, hemispherical, semi-hemispherical, line/linear, hyperbolic, parabolic, flat, curved, straight, arcuate, sinusoidal, tangent/tangential, etc.; direction—such as, north, south, east, west, etc.; surface and/or bulk material properties and/or spatial/temporal resolution and/or distribution—such as, smooth, reflective, transparent, clear, opaque, rigid, impermeable, uniform(ly), inert, non-wettable, insoluble, steady, invariant, constant, homogeneous, etc.; as well as many others that would be apparent to those skilled in the relevant arts. As one example, a fabricated article that would described herein as being “square” would not require such article to have faces or sides that are perfectly planar or linear and that intersect at angles of exactly 90 degrees (indeed, such an article can only exist as a mathematical abstraction), but rather, the shape of such article should be interpreted as approximating a “square,” as defined mathematically, to an extent typically achievable and achieved for the recited fabrication technique as would be understood by those skilled in the art or as specifically described. As another example, two or more fabricated articles that would described herein as being “aligned” would not require such articles to have faces or sides that are perfectly aligned (indeed, such an article can only exist as a mathematical abstraction), but rather, the arrangement of such articles should be interpreted as approximating “aligned,” as defined mathematically, to an extent typically achievable and achieved for the recited fabrication technique as would be understood by those skilled in the art or as specifically described.

1. A sensor for detecting a species, comprising:
a first electrode;
a second electrode; and
a graphene oxide component, wherein the graphene oxide component is in electrical communication with each of the first electrode and the second electrode, and wherein a response time of the sensor to a step change in an ambient relative humidity from 10% relative humidity to 50% relative humidity is less than or equal to 1 minute.

2. A sensor for detecting a species, comprising:
a first electrode;
a second electrode; and
a graphene oxide component, wherein the graphene oxide component is in electrical communication with each of the first electrode and the second electrode, and wherein a resistivity of the graphene oxide component varies substantially linearly with an ambient relative humidity when the ambient relative humidity is greater than or equal to 10% and less than or equal to 60%.

3-5. (canceled)

6. A method of forming a thin film or sensor component, comprising:
electrospraying a solution comprising a nanomaterial onto a substrate, wherein a temperature of the substrate is at least 15° C. greater than a temperature of the solution.

7. (canceled)

8. A sensor as in claim 1, wherein the graphene oxide component comprises graphene oxide nanoflakes.

9. A sensor as in claim 1, wherein the graphene oxide component has a thickness of less than or equal to 100 nm.

10. A sensor as in claim 1, wherein the graphene oxide component is unreduced.

11. A sensor as in claim 1, wherein the sensor is capable of detecting ammonia at a concentration of 500 ppm.

12-18. (canceled)

19. A sensor as in claim 1, wherein an active area of the sensor is greater than or equal to 0.05 mm² and less than or equal to 0.1 mm².

20-24. (canceled)

25. A sensor as in claim 1, wherein the sensor consumes less than 6 microwatts of power when exposed to air with a relative humidity of less than 60%.

26. A method for detecting a species, comprising exposing a sensor as in claim 1 to the species.

27. A method as in claim 26, wherein the species comprises a gas.

28. A method as in claim 26, wherein the species comprises water.

29. A method as in claim 26, wherein the species comprises ammonia.

30. A method as in claim 26, wherein the species comprises one or more of oxygen, carbon tetrafluoride, nitrous oxide, halogens, hydrochloric acid, and hydrofluoric acid.

31. A sensor as in claim 1, wherein a ratio of an increase in the resistivity of the graphene oxide component to an increase in the ambient relative humidity is greater than or equal to 1 and less than or equal to 2.

32. (canceled)

33. A sensor as in claim 1, wherein binder makes up less than or equal to 1 wt % of the component.

34. A method as in claim 6, wherein the solution is electrosprayed through a shadow mask.

35. A method as in claim 34, wherein the shadow mask has at least two layers.

36. A method as in claim 6, wherein the temperature of the substrate is between 40° C. and 65° C.

37. (canceled)

38. A sensor as in claim 1, wherein a response time of the sensor upon exposure to ammonia is less than or equal to 1 minute.

39-40. (canceled)
